(19) United States
(12) Patent Application Publication
(10) Pub. No.: US 2024/0312719 A1
(43) Pub. Date: Sep. 19, 2024

(54) ELECTRONIC COMPONENT

(71) Applicant: SAMSUNG ELECTRO-MECHANICS CO., LTD., Suwon-si (KR)

(72) Inventor: Beomjoon Cho, Suwon-si (KR)

(73) Assignee: SAMSUNG ELECTRO-MECHANICS CO., LTD., Suwon-si (KR)

(21) Appl. No.: 18/592,268

(22) Filed: Feb. 29, 2024

(30) Foreign Application Priority Data
Mar. 17, 2023 (KR) 10-2023-0035231

(51) Int. Cl. H01G 4/30; H01G 2/06; H01G 4/012; H01G 4/12; H01G 4/232

(52) U.S. Cl. CPC H01G 4/30; H01G 2/065; H01G 4/012; H01G 4/12; H01G 4/232

(57) ABSTRACT

An electronic component includes a capacitor body, a connection electrode, and an external electrode. The capacitor body includes a dielectric layer, and a plurality of internal electrodes disposed in a stacking direction and spaced apart from one another with the dielectric layer interposed therebetween, the capacitor body including first and second surfaces facing each other in the stacking direction. The connection electrode is connected to the plurality of internal electrodes in the capacitor body and each include an end exposed from the first surface. The external electrode is positioned on the first surface and connected to the connection electrode. The connection electrode includes a main junction portion extending in the stacking direction and configured to penetrate the plurality of internal electrodes, and a bypass portion connected to the main junction portion and extending in a planar direction in the dielectric layer.

### CROSS-REFERENCE TO RELATED APPLICATION

This application claims priority to and the benefit of Korean Patent Application No. 10-2023-0035231 filed in the Korean Intellectual Property Office on Mar. 17, 2023, the entire contents of which are incorporated herein by reference.

### BACKGROUND

### (a) Technical Field

The present disclosure relates to an electronic component, and more particularly, to a multilayer ceramic capacitor.

### (b) Description of the Related Art

A multilayer ceramic capacitor (MLCC) refers to a chip-shaped condenser mounted on a circuit board of various types of electronic products and configured to be charged with electricity or discharged. The multilayer ceramic capacitor has a structure in which internal electrodes having opposite polarities are alternately stacked one by one with dielectric layers (ceramic layers) interposed therebetween.

Recently, with the trend of manufacturing electronic products having high performance and multiple functions, the use of multilayer ceramic capacitors has increased. With the progress of miniaturization and integration of electronic components, there is a consistently increasing need for multilayer ceramic capacitors having small scales and high capacities. However, a technology for increasing the number of stacked internal electrodes or thinning a dielectric layer, which is a representative method capable of increasing capacitance, gradually approaches a technical limitation, which slows down the improvement.

Therefore, in order to increase capacitance in other aspects, there has been proposed a method of decreasing volumes of elements irrelevant to the implementation of capacity among constituent elements of the multilayer ceramic capacitor and increasing volumes of parts that contribute to the increase in capacity to the extent of the decreased volumes. For example, a representative method provides a configuration in which a connection electrode penetrates a dielectric layer and a plurality of internal electrodes.

The connection electrode may be manufactured by a process of forming through-holes in the dielectric layer and the plurality of internal electrodes, filling the through-holes with conductive materials, and then performing a sintering process. However, in this case, gaps may be formed between the connection electrode and the through-holes because of a difference in sintering contraction percentage between the dielectric layer, the internal electrode, and the conductive material, and outside moisture may penetrate through the gaps, which degrades moisture resistance reliability.

### SUMMARY

The present disclosure has been made in an effort to provide an electronic component capable of improving moisture resistance reliability by preventing outside moisture from penetrating into the electronic component through a connection electrode in a configuration in which the connection electrode is used to electrically connect a plurality of internal electrodes.

However, the object to be achieved by the embodiments of the present disclosure is not limited to the above-mentioned object but may be variously expanded without departing from the technical spirit of the present disclosure.

An electronic component according to an embodiment includes a capacitor body, a connection electrode, and an external electrode. The capacitor body includes a dielectric layer, a plurality of internal electrodes disposed in a stacking direction and spaced apart from one another with the dielectric layer interposed therebetween, and first and second surfaces facing each other in the stacking direction. The connection electrode includes a main junction portion extending in the stacking direction and configured to penetrate the plurality of internal electrodes, a bypass portion connected to the main junction portion and extending in a planar direction in the dielectric layer, and an end extending from the first surface. The connection electrode is connected to the plurality of internal electrodes in the capacitor body. The external electrode is positioned on the first surface and connected to the connection electrode.

The capacitor body may include a lowermost end dielectric layer configured to adjoin the first surface, and the bypass portion may be positioned in the lowermost end dielectric layer.

The lowermost end dielectric layer may have a larger thickness than the dielectric layer positioned between the plurality of internal electrodes.

The connection electrode may further include a conductive portion connected to the bypass portion. The conductive portion may extend in the stacking direction in the lowermost end dielectric layer, may extend to the first surface, and may be in contact with the external electrode.

The planar direction may include first and second directions orthogonal to each other, and the capacitor body may include third and fourth surfaces facing each other in the first direction. The plurality of internal electrodes may include a plurality of first internal electrodes and a plurality of second internal electrodes alternately positioned one by one in the stacking direction. Edges of the plurality of first internal electrodes may be extended from the third surface, and edges of the plurality of second internal electrodes may be extended from the fourth surface.

The bypass portion may be positioned to extend in the second direction.

The plurality of first internal electrodes may be positioned at a distance from the fourth surface, and the plurality of second internal electrodes may be positioned at a distance from the third surface. The connection electrode may include: a first connection electrode connected to the plurality of first internal electrodes, the first connection electrode may include a first main junction portion positioned between the third surface and the plurality of second internal electrodes; and a second connection electrode connected to the plurality of second internal electrodes, the second connection electrode may include a second main junction portion positioned between the fourth surface and the plurality of first internal electrodes.

The first connection electrode may include a plurality of first connection electrodes, and the second connection electrode may include a plurality of second connection electrodes. The plurality of first connection electrodes may be spaced apart from each other in the second direction, and the plurality of second connection electrodes may be spaced apart from each other in the second direction.

The capacitor body may further include an insulation layer configured to cover the third surface and the fourth surface.

An electronic component according to another embodiment includes a capacitor body, a connection electrode, and an external electrode. The capacitor body includes a dielectric layer, a plurality of internal electrodes disposed in a stacking direction and spaced apart from one another with the dielectric layer interposed therebetween, and first and second surfaces facing each other in the stacking direction. The connection electrode is configured to penetrate the plurality of internal electrodes and connected to the plurality of internal electrodes, and the connection electrode has at least one bent portion in the capacitor body and an end extending from the first surface. The external electrode is positioned on the first surface and connected to the connection electrode.

The at least one bent portion may include a first bent portion. The connection electrode may further include a main junction portion extending in the stacking direction and configured to penetrate the plurality of internal electrodes, and a bypass portion connected to the main junction portion by means the first bent portion and extending in a planar direction in the dielectric layer. The first bent portion may have any one of a shape bent at a right angle and a shape roundly bent.

The at least one bent portion may further include a first bent portion. The connection electrode may further include a conductive portion connected to the bypass portion by the second bent portion. The conductive portion may extend in the stacking direction in the dielectric layer, may extend to the first surface, and may be in contact with the external electrode. The second bent portion may have any one of a shape bent at a right angle and a shape roundly bent.

The capacitor body may further include a lowermost end dielectric layer configured to adjoin the first surface, and the bypass portion and the conductive portion may be positioned in the lowermost end dielectric layer.

The lowermost end dielectric layer may have a larger thickness than the dielectric layer positioned between the plurality of internal electrodes.

The connection electrode may include a plurality of connection electrodes spaced apart from each other.

An electronic component according to an embodiment includes a capacitor body, a connection electrode, and an external electrode. The capacitor body includes a dielectric layer, a plurality of internal electrodes disposed in a stacking direction and spaced apart from one another with the dielectric layer interposed therebetween, and first and second surfaces facing each other in the stacking direction. The connection electrode includes a main junction portion extending in the stacking direction and configured to penetrate the plurality of internal electrodes, a bypass portion connected to the main junction portion and extending in a direction substantially crossing the stacking direction, and an end extending from the first surface. The connection electrode is connected to the plurality of internal electrodes in the capacitor body. The external electrode is positioned on the first surface and connected to the connection electrode.

The connection electrode may further include a conductive portion connected to the bypass portion. In a cross-section of the electronic component in the stacking direction and a direction orthogonal to the stacking direction, a central axis of the main junction portion along the stacking direction may be offset from a central axis of the conductive portion along the stacking direction.

In a cross-section of the electronic component in the stacking direction and a direction orthogonal to the stacking direction, the main junction portion and the conductive portion may not overlap each other along the stacking direction.

The main junction portion may penetrate through at least one internal electrode among the plurality of internal electrodes.

In the electronic component according to the embodiment, the penetration of moisture is blocked by the bypass route in the capacitor body even though the moisture is intended to penetrate into the connection electrode from the outside. Therefore, the electronic component according to the embodiment may improve the moisture resistance reliability by effectively blocking the penetration of moisture into the main junction portion.

### BRIEF DESCRIPTION OF THE DRAWINGS

FIG. 1 is a perspective view illustrating an external shape of an electronic component according to an embodiment.

FIG. 2 is a cross-sectional view of the electronic component taken along line II-II′ in FIG. 1.

FIG. 3 is a cross-sectional view of the electronic component taken along line III-III′ in FIG. 1.

FIG. 4 is a cross-sectional view of the electronic component taken along line IV-IV′ in FIG. 1.

FIG. 5 is an exploded perspective view of a capacitor body of the electronic component illustrated in FIG. 1.

FIGS. 6 and 7 are cross-sectional views illustrating an interior of an electronic component according to another embodiment.

### DETAILED DESCRIPTION OF THE EMBODIMENTS

Hereinafter, embodiments of the present disclosure will be described in detail with reference to the accompanying drawings so that those with ordinary skill in the art to which the present disclosure pertains may easily carry out the embodiments. In the drawings, a part irrelevant to the description will be omitted to clearly describe the present disclosure, and the same or similar constituent elements will be designated by the same reference numerals throughout the specification. Some constituent elements in the accompanying drawings are illustrated in an exaggerated or schematic form or are omitted. A size of each constituent element does not entirely reflect an actual size.

In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

In addition, when one component such as a layer, a film, a region, or a plate is described as being positioned “above” or “on” another component, one component can be positioned “directly on” another component, and one component can also be positioned on another component with other components interposed therebetween. On the contrary, when one component is described as being positioned “directly above” another component, there is no component therebetween. In addition, when a component is described as being positioned “above” or “on” a reference part, the component may be positioned “above” or “below” the reference part, and this configuration does not necessarily mean that the component is positioned “above” or “on” the reference part in a direction opposite to gravity.

Throughout the specification, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof. Therefore, unless explicitly described to the contrary, the word “comprise/include” and variations such as “comprises/includes” or “comprising/including” will be understood to imply the inclusion of stated elements, not the exclusion of any other elements.

Throughout the specification, the word “in a plan view” means when an object is viewed from above, and the word “in a cross-sectional view” means when a cross section made by vertically cutting an object is viewed from a lateral side.

Throughout the specification, when one constituent element is referred to as being “connected to” another constituent element, one constituent element can be “directly connected to” the other constituent element, and one constituent element can also be “indirectly connected to,” “physically connected to,” or “electrically connected to” the other element with other elements therebetween. Further, the constituent elements are defined as different names according to positions or functions thereof, but the constituent elements may be integrated.

In the present specification, in describing the electronic component, a direction in which main components of the electronic component are stacked is defined as a ‘stacking direction’ that may be a ‘thickness direction’. In addition, a direction parallel to a plane perpendicular to the stacking direction may be defined as a ‘planar direction’, and the planar direction may include a ‘first direction’ and a ‘second direction’ that are orthogonal to each other.

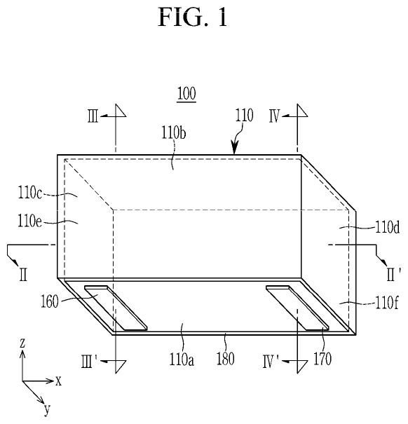

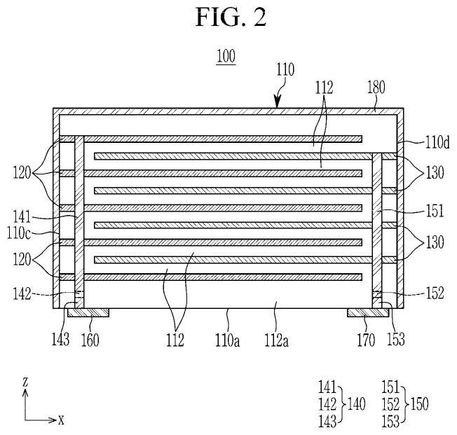

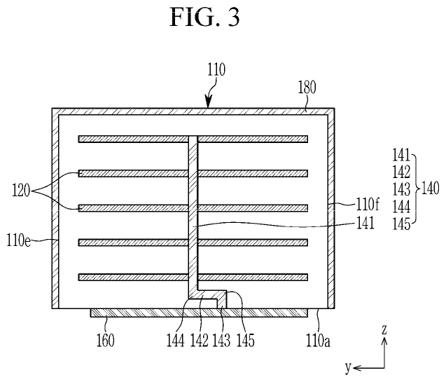

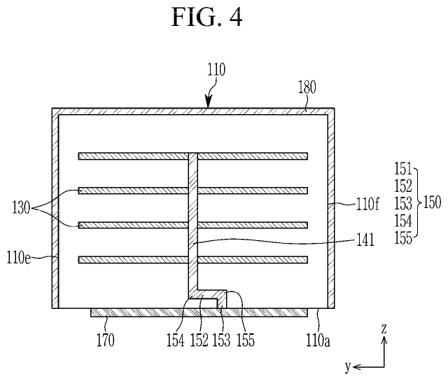

FIG. 1 is a perspective view illustrating an external shape of an electronic component according to an embodiment, and FIG. 2 is a cross-sectional view of the electronic component taken along line II-II′ in FIG. 1. FIG. 3 is a cross-sectional view of the electronic component taken along line III-III′ in FIG. 1, and FIG. 4 is a cross-sectional view of the electronic component taken along line IV-IV′ in FIG. 1.

With reference to FIGS. 1 to 4, an electronic component 100 according to an embodiment is a multilayer ceramic capacitor, and specifically includes a capacitor body 110, a first connection electrode 140, a second connection electrode 150, a first external electrode 160, and a second external electrode 170.

The capacitor body 110 may include a plurality of dielectric layers 112, and a plurality of internal electrodes 120 and 130 disposed in the stacking direction (z-axis direction in the drawings) and spaced apart from one another with one dielectric layer 112 interposed therebetween. The plurality of internal electrodes 120 and 130 may include first and second internal electrodes 120 and 130 alternately positioned in the stacking direction.

The capacitor body 110 may have an approximately hexahedral shape and include first and second surfaces 110a and 110b facing each other in the stacking direction, third and fourth surfaces 110c and 110d facing each other in a first direction (x-axis direction in the drawings), and fifth and sixth surfaces 110e and 110f facing each other in a second direction (y-axis direction in the drawings). The first surface 110a and the second surface 110b may be respectively a lower surface and an upper surface of the capacitor body 110. The third surface 110c and the fourth surface 110d may be respectively a left surface and a right surface of the capacitor body 110. The fifth surface 110e and the sixth surface 110f may be respectively a front surface and a rear surface of the capacitor body 110.

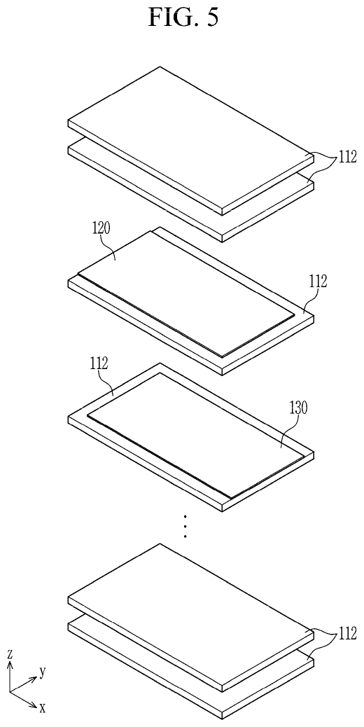

FIG. 5 is an exploded perspective view of a capacitor body of the electronic component illustrated in FIG. 1.

With reference to FIG. 5, the plurality of dielectric layers 112 may be disposed in the stacking direction, any one of the first internal electrode 120 and the second internal electrode 130 is positioned on each of the dielectric layers 112. The first internal electrode 120 and the second internal electrode 130 may be alternately positioned one by one in the stacking direction and each have a smaller area than the dielectric layer 112.

The dielectric layer 112 may include a ceramic material having high permittivity. For example, the ceramic material may include dielectric ceramic containing substances such as BaTiO₃, CaTiO₃, SrTiO₃, or GaZrO₃. In addition, the ceramic material may further include auxiliary substances such as a Mn compound, a Fe compound, a Cr compound, a Co compound, and a Ni compound in addition to the above-mentioned substances. For example, the ceramic material may be (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like made by partially applying Ca, Zr, or the like to BaTiO₃-based dielectric ceramic.

The first and second internal electrodes 120 and 130 may be manufactured by printing conductive paste containing metal onto the dielectric layer 112. The first and second internal electrodes 120 and 130 may each include Ni, Cu, Pd, and Ag as main substances.

One side (left) edge of the first internal electrode 120 may overlap, in the stacking direction, one side (left) edge of two opposite side edges of the dielectric layer 112 based on the first direction. The other side (right) edge of the second internal electrode 130 may overlap, in the stacking direction, the other side (right) edge of the two opposite side edges of the dielectric layer 112 based on the first direction. As necessary, the dielectric layers 112 may be additionally disposed at two opposite ends (an uppermost end and a lowermost end) based on the stacking direction.

The capacitor body 110 may be manufactured by disposing the plurality of dielectric layers 112 and the first and second internal electrodes 120 and 130 in the above-mentioned way and then performing a sintering process. In the capacitor body 110 that has been subjected to the sintering process, the plurality of dielectric layers 112 may be integrated to the extent that boundaries therebetween cannot be identified.

With reference back to FIGS. 1 to 4, an edge of the first internal electrode 120 may be exposed from the third surface 110c of the capacitor body 110, and an edge of the second internal electrode 130 may be exposed from the fourth surface 110d of the capacitor body 110. The capacitor body 110 may at least include an insulation layer 180 positioned on the third surface 110c and the fourth surface 110d. The insulation layer 180 may at least cover the third surface 110c and the fourth surface 110d to prevent the edges of the first and second internal electrodes 120 and 130 from being exposed from the outside of the capacitor body 110.

The insulation layer 180 may be positioned on the remaining surfaces of the capacitor body 110, except for the first surface 110a, i.e., positioned on the second to sixth surfaces 110b, 110c, 110d, 110e, and 110f. For example, the insulation layer 180 may be manufactured by coating the second to sixth surfaces 110b, 110c, 110d, 110e, and 110f of the capacitor body 110 with insulating resin and then performing a drying process. The insulation layer 180 serves to improve durability and reliability of the capacitor body 110.

The first connection electrode 140 is connected to the plurality of first internal electrodes 120 in the capacitor body 110, and the second connection electrode 150 is connected to the plurality of second internal electrodes 130 in the capacitor body 110. The first connection electrode 140 and the second connection electrode 150 are positioned at a distance therebetween in the first direction. The ends of the first and second connection electrodes 140 and 150 may be exposed from the first surface 110a of the capacitor body 110.

The first connection electrode 140 may include a main junction portion 141 extending in the stacking direction and configured to penetrate the plurality of first internal electrodes 120, and a bypass portion 142 connected to the main junction portion 141 and extending in a planar direction in the dielectric layer 112. In some embodiments of the application, the bypass portion 142 may extend in a direction substantially crossing the stacking direction. For example, the direction substantially crossing the stacking direction may form an angle of more than 0° and 90° or less with the stacking direction. The second connection electrode 150 may include a main junction portion 151 extending in the stacking direction and configured to penetrate the plurality of second internal electrodes 130, and a bypass portion 152 connected to the main junction portion 151 and extending in the planar direction in the dielectric layer 112.

The main junction portion 141 of the first connection electrode 140 may be positioned to be close to the third surface 110c of the capacitor body 110 so as not to adjoin the second internal electrode 130. That is, the main junction portion 141 of the first connection electrode 140 may be positioned at a distance from the edge of the second internal electrode 130 in the first direction and positioned between the third surface 110c of the capacitor body 110 and the edge of the second internal electrode 130.

The main junction portion 151 of the second connection electrode 150 may be positioned to be close to the fourth surface 110d of the capacitor body 110 so as not to adjoin the first internal electrode 120. That is, the main junction portion 151 of the second connection electrode 150 may be positioned at a distance from the edge of the first internal electrode 120 in the first direction and positioned between the fourth surface 110d of the capacitor body 110 and the edge of the first internal electrode 120.

The main junction portion 141 of the first connection electrode 140 may penetrate the plurality of first internal electrodes 120 and the plurality of dielectric layers 112 in the stacking direction and be in contact with and electrically connected to the plurality of first internal electrodes 120. The main junction portion 151 of the second connection electrode 150 may penetrate the plurality of second internal electrodes 130 and the plurality of dielectric layers 112 in the stacking direction and be in contact with and electrically connected to the plurality of second internal electrodes 130.

One end (lower end) of each of the main junction portions 141 and 151 may be positioned at a distance from the first surface 110a of the capacitor body 110. Specifically, one end (lower end) of each of the main junction portions 141 and 151 may be positioned in a lowermost end dielectric layer (indicated by ‘112a’ in FIG. 2, for convenience) which adjoins the first surface 110a among the plurality of dielectric layers 112 that constitute the capacitor body 110. The lowermost end dielectric layer 112a may be a dielectric layer, which is positioned between a lowermost end internal electrode and the first surface 110a among the plurality of internal electrodes 120 and 130, and have a larger thickness than the dielectric layer 112 positioned between the first internal electrode 120 and the second internal electrode 130. The thickness of each of the dielectric layers may be measured by, for example, scanning electron microscopy. Other methods and/or tools appreciated by one of ordinary skill in the art, even if not described in the present disclosure, may also be used.

The bypass portions 142 and 152 may each be connected to one end (lower end) of each of the main junction portions 141 and 151 in the lowermost end dielectric layer 112a and positioned to extend in the planar direction. The bypass portions 142 and 152 may extend in the second direction (y-axis direction in the drawings) of the planar direction.

Assuming that the bypass portions 142 and 152 extend in the first direction (x-axis direction in the drawings) of the planar direction, a distance between the bypass portions 142 and 152 of the first and second connection electrodes 140 and 150 may become closer, and a distance between the first and second external electrodes 160 and 170 to be described below may become closer. In this case, interference may occur between the first connection electrode 140 and the second connection electrode 150. The bypass portions 142 and 152 may extend in the second direction of the planar direction and prevent the interference between the first and second connection electrodes 140 and 150.

The main junction portions 141 and 151 extend in the stacking direction, and the bypass portions 142 and 152 extend in the second direction, such that the first bent portions 144 and 154 are present between the main junction portions 141 and 151 and the bypass portions 142 and 152. The first bent portions 144 and 154 may each have various shapes such as a shape bent at a right angle or a shape bent roundly while having a predetermined curvature. FIGS. 3 and 4 illustrates the first example. However, the shapes of the first bent portions 144 and 154 are not limited to the illustrated examples.

The first and second connection electrodes 140 and 150 may include conductive portions 143 and 153 connected to ends of the bypass portions 142 and 152. The conductive portions 143 and 153 may extend in the stacking direction in the lowermost end dielectric layer 112a and be exposed from the first surface 110a of the capacitor body 110. That is, the ends of the conductive portions 143 and 153 may be the ends of the first and second connection electrodes 140 and 150.

The bypass portions 142 and 152 extend in the second direction, and the conductive portions 143 and 153 extend in the stacking direction, such that second bent portions 145 and 155 are present between the bypass portions 142 and 152 and the conductive portions 143 and 153. The second bent portions 145 and 155 may each have various shapes such as a shape bent at a right angle or a shape bent roundly while having a predetermined curvature. FIGS. 3 and 4 illustrates the first example. However, the shapes of the second bent portions 145 and 155 are not limited to the illustrated examples.

As described above, the first and second connection electrodes 140 and 150 are connected to the plurality of internal electrodes 120 and 130 by means of the main junction portions 141 and 151. The main junction portions 141 and 151 may be connected to the bypass portions 142 and 152 and the conductive portions 143 and 153 without being exposed directly from the first surface 110a of the capacitor body 110. In the capacitor body 110, the first and second connection electrodes 140 and 150 may each have lengths extended by the bypass portions 142 and 152 and the conductive portions 143 and 153 and each have the two bent portions 144, 145, 154, and 155 in the capacitor body 110.

The first external electrode 160 and the second external electrode 170 may be positioned on the first surface 110a of the capacitor body 110 and positioned at a distance therebetween in the first direction. The first external electrode 160 may be connected to the first connection electrode 140 by coming into contact with the end of the first connection electrode 140, and the second external electrode 170 may be connected to the second connection electrode 150 by coming into contact with the end of the second connection electrode 150. The first and second external electrodes 160 and 170 may be mounted on a circuit board (not illustrated) of an electronic product and electrically connect the plurality of internal electrodes 120 and 130 and the circuit board.

The first and second connection electrodes 140 and 150 may be manufactured by forming through-holes in the capacitor body 110, filling the through-holes with conductive materials, and performing a sintering process. For example, the first and second connection electrodes 140 and 150 may be manufactured by forming through-holes in the capacitor body 110 by using a laser or the like, filling the through-holes with conductive materials containing metal, and then performing a sintering process.

Meanwhile, during the sintering process, fine gaps may be formed around the first and second connection electrodes 140 and 150 because of a difference in contraction percentage between the constituent materials of the capacitor body 110 and the constituent materials of the first and second connection electrodes 140 and 150. Degrees to which the gaps are formed may be different in the main junction portions 141 and 151 and the bypass portions 142 and 152.

Specifically, the main junction portions 141 and 151, the dielectric layer 112, and the internal electrodes 120 and 130 are alternately in contact with one another in the stacking direction. The three types of constituent elements including the main junction portions 141 and 151, the dielectric layer 112, and the internal electrodes 120 and 130 may mechanically interact with one another to produce various changes in contraction percentage. In contrast, the bypass portions 142 and 152 and the conductive portions 143 and 153 are in contact with the single material, i.e., the dielectric layer 112. Therefore, the occurrence of gaps may be further suppressed in the bypass portions 142 and 152 and the conductive portions 143 and 153 than in the main junction portions 141 and 151. The bypass portions 142 and 152 and the conductive portions 143 and 153 may implement very close contact surfaces with the dielectric layer 112.

As a result, even though moisture is intended to penetrate into the main junction portions 141 and 151 from the outside of the electronic component 100, the penetration of moisture is blocked by bypass routes including the conductive portions 143 and 153 and the bypass portions 142 and 152. Therefore, the electronic component 100 according to the embodiment may improve moisture resistance reliability by effectively blocking the penetration of moisture into the main junction portions 141 and 151.

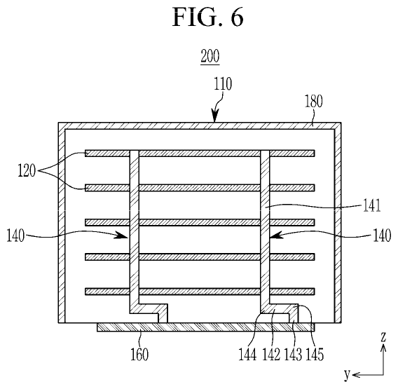

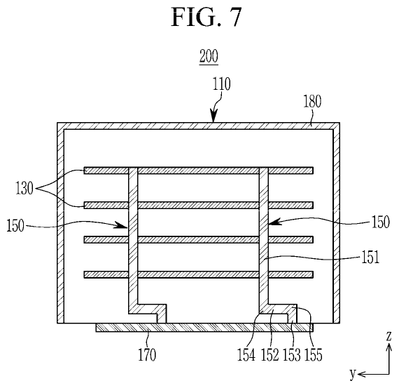

FIGS. 6 and 7 are cross-sectional views illustrating an interior of an electronic component according to another embodiment.

With reference to FIGS. 6 and 7, an electronic component 200 according to the present embodiment may include the same basic configuration as the electronic component 100 according to the embodiment described with reference to FIGS. 1 to 4, except that the first connection electrode 140 is provided as a plurality of first connection electrodes 140, and the second connection electrode 150 is provided as a plurality of second connection electrodes 150.

The plurality of first connection electrodes 140 may be positioned between the third surface 110c (see FIG. 1) of the capacitor body 110 and the plurality of second internal electrodes 130 and positioned at distances therebetween in the second direction. The plurality of second connection electrodes 150 may be positioned between the fourth surface 110d (see FIG. 1) of the capacitor body 110 and the plurality of first internal electrodes 120 and positioned at distances therebetween in the second direction.

The plurality of first connection electrodes 140 may be connected to the first external electrode 160, and the plurality of second connection electrodes 150 may be connected to the second external electrode 170. FIGS. 6 and 7 illustrate that two first connection electrodes 140 and two second connection electrodes 150 are disposed. However, the number of first and second connection electrodes 140 and 150 is not limited to the illustrated example.

In the electronic component 200 of the present embodiment, even though any one of the first connection electrodes 140 or any one of the second connection electrodes 150 is disconnected in the capacitor body 110, another first connection electrode 140 or another second connection electrode 150 may serve to connect the plurality of internal electrodes 120 and 130, thereby implementing an effect of reducing a risk caused by the disconnection.

Next, experiments for evaluating moisture resistance reliability on electronic components according to Example 1, Example 2, and Comparative Example will be described.

The electronic component of Example 1 is the electronic component according to the embodiment described with reference to FIGS. 1 to 4, and the electronic component of Example 2 is the electronic component according to the embodiment described with reference to FIGS. 6 and 7 in which the two first connection electrodes and the two second connection electrodes are provided. The electronic component of Example 2 includes the same basic configuration as the electronic component of Example 1, except for the number of first and second connection electrodes. The electronic component of the Comparative Example includes the same basic configuration as the electronic component of Example 1, except that the first and second connection electrodes are straight shapes parallel to the stacking direction.

Forty electronic components of each of Example 1, Example 2, and Comparative Example were prepared and mounted on circuit boards. Then, moisture resistance reliability was measured by using ESPEC (PR-3J) equipment under a condition of 85° C., relative humidity (R.H.) of 85%, 2Vr (twice a rated voltage), and 300 hours. The results are shown in Table 1 below.

TABLE 1

| | Defect rate (%) |
|---|---|
| Comparative | 47.5 |
| Example | |
| Example 1 | 0 |
| Example 2 | 0 |

It can be seen that in the case of the electronic component of Comparative Example in which the first and second connection electrodes are straight shapes, an insulation resistance defect occurs on half of the electronic component because of penetration of moisture. In contrast, no insulation resistance defect caused by penetration of moisture occurs on the electronic component of Examples 1 and 2. The electronic components of Examples 1 and 2 may provide the bypass routes on the connection electrode, thereby preventing the insulation resistance defect caused by the penetration of moisture.

While the embodiments of the present disclosure have been described above, the present disclosure is not limited thereto, and various modifications can be made and carried out within the scope of the claims, the detailed description of the disclosure, and the accompanying drawings, and also fall within the scope of the present disclosure.

What is claimed is:

1. An electronic component comprising:
a capacitor body comprising:
a dielectric layer;
a plurality of internal electrodes disposed in a stacking direction and spaced apart from one another with the dielectric layer interposed therebetween; and
first and second surfaces facing each other in the stacking direction;
a connection electrode comprising:
a main junction portion extending in the stacking direction and configured to penetrate the plurality of internal electrodes;
a bypass portion connected to the main junction portion and extending in a planar direction in the dielectric layer; and
an end extending from the first surface, wherein the connection electrode is connected to the plurality of internal electrodes in the capacitor body; and
an external electrode positioned on the first surface and connected to the connection electrode.

2. The electronic component of claim 1, wherein:
the capacitor body comprises a lowermost end dielectric layer configured to adjoin the first surface, and
the bypass portion is positioned in the lowermost end dielectric layer.

3. The electronic component of claim 2, wherein:
the lowermost end dielectric layer has a larger thickness than the dielectric layer positioned between the plurality of internal electrodes.

4. The electronic component of claim 2, wherein:
the connection electrode further comprises a conductive portion connected to the bypass portion, and
the conductive portion extends in the stacking direction in the lowermost end dielectric layer, extends to the first surface, and is in contact with the external electrode.

5. The electronic component of claim 1, wherein:
the planar direction comprises first and second directions orthogonal to each other,
the capacitor body comprises third and fourth surfaces facing each other in the first direction,
the plurality of internal electrodes comprises a plurality of first internal electrodes and a plurality of second internal electrodes alternately positioned one by one in the stacking direction, and
edges of the plurality of first internal electrodes extend from the third surface, and edges of the plurality of second internal electrodes extend from the fourth surface.

6. The electronic component of claim 5, wherein:
the bypass portion is positioned to extend in the second direction.

7. The electronic component of claim 5, wherein:
the plurality of first internal electrodes is positioned at a distance from the fourth surface, the plurality of second internal electrodes is positioned at a distance from the third surface,
the connection electrode includes:
a first connection electrode connected to the plurality of first internal electrodes, the first connection electrode comprises a first main junction portion positioned between the third surface and the plurality of second internal electrodes; and a second connection electrode connected to the plurality of second internal electrodes, the second connection electrode comprises a second main junction portion positioned between the fourth surface and the plurality of first internal electrodes.

8. The electronic component of claim 7, wherein:
the first connection electrode includes a plurality of first connection electrodes, the second connection electrode includes a plurality of second connection electrodes,
the plurality of first connection electrodes is spaced apart from each other in the second direction, and
the plurality of second connection electrodes is spaced apart from each other in the second direction.

9. The electronic component of claim 7, wherein:
the capacitor body further comprises an insulation layer configured to cover the third surface and the fourth surface.

10. An electronic component comprising:
a capacitor body comprising:
a dielectric layer;
a plurality of internal electrodes disposed in a stacking direction and spaced apart from one another with the dielectric layer interposed therebetween; and
first and second surfaces facing each other in the stacking direction;
a connection electrode configured to penetrate the plurality of internal electrodes and connected to the plurality of internal electrodes, the connection electrode comprising at least one bent portion in the capacitor body and an end extending from the first surface; and
an external electrode positioned on the first surface and connected to the connection electrode.

11. The electronic component of claim 10, wherein:
the at least one bent portion includes a first bent portion, and
the connection electrode further comprises:
a main junction portion extending in the stacking direction and configured to penetrate the plurality of internal electrodes; and
a bypass portion connected to the main junction portion by the first bent portion and extending in a planar direction in the dielectric layer.

12. The electronic component of claim 11, wherein:
the at least one bent portion further includes a second bent portion, and
the connection electrode further comprises a conductive portion connected to the bypass portion by the second bent portion, where the conductive portion extends in the stacking direction in the dielectric layer, extends to the first surface, and is in contact with the external electrode.

13. The electronic component of claim 12, wherein:
the capacitor body further comprises a lowermost end dielectric layer configured to adjoin the first surface, and
the bypass portion and the conductive portion are positioned in the lowermost end dielectric layer.

14. The electronic component of claim 13, wherein:
the lowermost end dielectric layer has a larger thickness than the dielectric layer positioned between the plurality of internal electrodes.

15. The electronic component of claim 11, wherein:
the connection electrode includes a plurality of connection electrodes spaced apart from each other.

16. An electronic component comprising:
a capacitor body comprising:
a dielectric layer;
a plurality of internal electrodes disposed in a stacking direction and spaced apart from one another with the dielectric layer interposed therebetween; and
first and second surfaces facing each other in the stacking direction;
a connection electrode comprising:
a main junction portion extending in the stacking direction and configured to penetrate the plurality of internal electrodes;
a bypass portion connected to the main junction portion and extending in a direction substantially crossing the stacking direction; and
an end extending from the first surface, wherein the connection electrode is connected to the plurality of internal electrodes in the capacitor body; and
an external electrode positioned on the first surface and connected to the connection electrode.

17. The electronic component of claim 16, wherein:
the connection electrode further comprises a conductive portion connected to the bypass portion,
in a cross-section of the electronic component in the stacking direction and a direction orthogonal to the stacking direction, a central axis of the main junction portion along the stacking direction is offset from a central axis of the conductive portion along the stacking direction.

18. The electronic component of claim 16, wherein:
in a cross-section of the electronic component in the stacking direction and a direction orthogonal to the stacking direction, the main junction portion and the end do not overlap each other along the stacking direction.

19. The electronic component of claim 16, wherein the main junction portion penetrates through at least one internal electrode among the plurality of internal electrodes.
